(19) United States
(12) Patent Application Publication
(10) Pub. No.: US 2020/0311412 A1
(43) Pub. Date: Oct. 1, 2020

(54) INFERRING TITLES AND SECTIONS IN DOCUMENTS

(71) Applicant: Konica Minolta Laboratory U.S.A., Inc., San Mateo, CA (US)

(72) Inventor: Tim Prebble, Longmont, CO (US)

(73) Assignee: Konica Minolta Laboratory U.S.A., Inc., San Mateo, CA (US)

(21) Appl. No.: 16/370,110

(22) Filed: Mar. 29, 2019

(51) Int. Cl. G06K 9/00; G06N 5/04; G06N 3/02; G06F 17/22; G06F 17/21; G06F 17/27; G06K 9/62

(52) U.S. Cl. CPC G06K 9/00469; G06N 5/04; G06N 3/02; G06F 17/2288; G06F 17/2705; G06F 17/2745; G06F 17/2785; G06K 9/6261; G06F 17/218

(57) ABSTRACT

A method for processing an electronic document (ED) to infer titles and sections in the ED includes: applying visual analysis to the ED and identifying candidate titles and candidate sections of the ED; filtering the candidate titles based on the candidate sections; filtering the candidate sections based on the filtered candidate titles; applying semantic analysis to the ED and identifying topics and portions of the ED; refining, based on the identified topics and the portions, the filtered candidate titles and the filtered candidate sections; and generating a marked-up version of the ED that identifies the refined candidate titles and the refined candidate sections.

### BACKGROUND

Titles and sections of a document aid users in reaching a preliminary understanding of the document's contents. Electronic documents (e.g., OOXML document, PDF document, etc.) include tags that help users identify these titles and sections. However, depending on how the electronic documents are created, not all titles and sections may be identified by tags, and incorrect tagging of titles and sections may occur. Regardless, users still wish to be able to accurately identify the titles and sections of these electronic documents.

### SUMMARY

In general, in one aspect, the invention relates to a method for processing an electronic document (ED) to infer titles and sections in the ED. The method comprising: applying visual analysis to the ED and identifying candidate titles and candidate sections of the ED; filtering the candidate titles based on the candidate sections; filtering the candidate sections based on the filtered candidate titles; applying semantic analysis to the ED and identifying topics and portions of the ED; refining, based on the identified topics and the portions, the filtered candidate titles and the filtered candidate sections; and generating a marked-up version of the ED that identifies the refined candidate titles and the refined candidate sections.

In general, in one aspect, the invention relates to a non-transitory computer readable medium (CRM) storing computer readable program code for processing an electronic document (ED) to infer titles and sections in a parsed version of the ED embodied therein. The computer readable program code causes a computer to: apply visual analysis to the ED and identify candidate titles and candidate sections of the ED; filter the candidate titles based on the candidate sections; filter the candidate sections based on the filtered candidate titles; apply semantic analysis to the ED and identify topics and portions of the ED; refine, based on the identified topics and the portions, the filtered candidate titles and the filtered candidate sections; and generate a marked-up version of the ED that identifies the refined candidate titles and the refined candidate sections.

In general, in one aspect, the invention relates to a system for processing an electronic document (ED) to infer titles and sections in a parsed version of the ED. The system comprising: a memory; and a processor coupled to the memory. The processor: applies visual analysis to the ED and identifies candidate titles and candidate sections of the ED; filters the candidate titles based on the candidate sections; filters the candidate sections based on the filtered candidate titles; applies semantic analysis to the ED and identifies topics and portions of the ED; refines, based on the identified topics and the portions, the filtered candidate titles and the filtered candidate sections; and generates a marked-up version of the ED that identifies the refined candidate titles and the refined candidate sections.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIGS. 3A-3E show an implementation example in accordance with one or more embodiments of the invention.

FIG. 4 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method, a non-transitory computer readable medium (CRM), and a system for processing an electronic document (ED) to infer titles and sections of the ED. Specifically, an ED including one or more pages and at least one section is obtained. The ED may or may not include a title. One or more processes applying a combination of visual and semantic analyses are executed on the ED to obtain content information (e.g., candidate titles, candidate sections, topics, and portions of the ED). With the contents of the ED identified, the titles and sections of the ED can be inferred even if they are not explicitly identified (i.e., labeled and/or tagged).

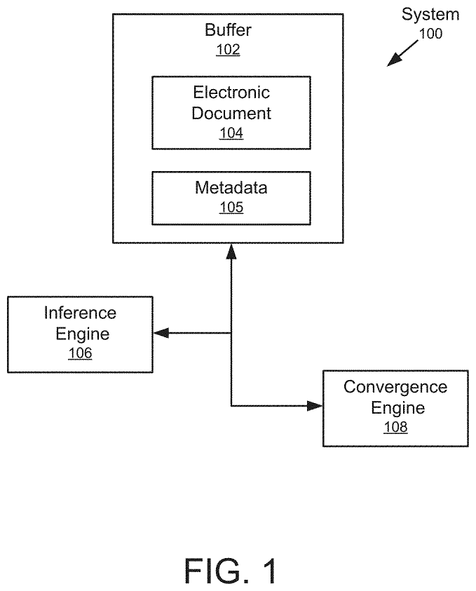

FIG. 1 shows a system (100) in accordance with one or more embodiments of the invention. As shown in FIG. 1, the system (100) has multiple components, including, for example, a buffer (102), an inference engine (106), and a convergence engine (108). Each of these components (102, 106, and 108) may be located on the same computing device (e.g., personal computer (PC), laptop, tablet PC, smart phone, multifunction printer, kiosk, server, etc.) or on different computing devices connected by a network of any size having wired and/or wireless segments. Each of these components is discussed below.

The buffer (102) may be implemented in hardware (i.e., circuitry), software, or any combination thereof. The buffer (102) is configured to store an electronic document (ED) (104). The ED (104) may include a combination of one or more lines of texts made up of characters and non-text objects (e.g., images, graphics, tables, charts, graphs, etc.). The ED (104) may be obtained (e.g., downloaded, scanned, etc.) from any source. The ED (104) may be a single-paged document or a multi-paged document. Further, the ED (104) may be of any size and in any format (e.g., PDF, OOXML, ODF, HTML, etc.).

The system (100) includes the inference engine (106). The inference engine (106) may be implemented in hardware (i.e., circuitry), software, or any combination thereof. The inference engine (106) parses the ED (104) to extract content, layout, and styling information of the characters in the ED (104) and generates a parsed version of the ED (104) based on the extracted information. The parsed version of the ED (104) may be stored in the buffer (102). Alternatively, the inference engine (106) renders the ED (104) into a bitmap object and stores the rendered bitmap of the ED (104) in the buffer (102).

The inference engine (106) further applies visual analysis to the ED (106) to identify candidate (i.e., potential) titles and sections based on the layout and styling information of the characters in the parsed version or the rendered bitmap of the ED (104). Visual analysis may be applied using any system, program, software, or combination thereof (herein referred to as “visual inferencers”) that are able to accurately recognize candidate titles and sections using the layout and styling information of the characters and/or the rendered bitmap of the ED (104). For example, the visual inferencers may be any one of a Convolution Neural Network, a Recurrent Neural Network, or a combination thereof that is trained (e.g., using artificial intelligence) to recognize the titles and sections of a document.

A candidate title may include any text or combination of texts that identify any one of: a name of the ED (104) as a whole, a section of the ED (104), and/or any non-text objects within the ED (104). Candidate titles may be visually distinct from other texts in the ED (104) (e.g., candidate titles may have larger font sizes, different font styles, different font colors, or a combination thereof). The ED (104) need not necessarily include any candidate titles.

A candidate section may include a piece of the ED (104) with content that is visually distinct from other contents of the ED (104) (e.g., a paragraph or a group of paragraphs, any of the non-text objects, etc.). A candidate section may be a major section that includes two or more minor sections that are nested or presented in a hierarchical manner. The ED (104) must include at least one candidate section (e.g., a candidate section covering an entirety of the ED). Each candidate section of the ED (104) may be associated with a candidate title.

The inference engine (106) further applies semantic analysis to the ED (104) to identify topics and portions based on the content information of the characters in the parsed version or based on the rendered bitmap of the of the ED (104). The semantic analysis may be applied using any system, program, software, or combination thereof (herein referred to as “semantic inferencers”) that are able to accurately recognize the semantics (i.e., meaning and logic) of the texts in the ED (104). For example, the semantic analysis may be applied using one or more Natural Language Processing (NLP) techniques.

In one or more embodiments, a topic of the ED (104) is the subject matter of the entire or one or more parts of the ED (104). The ED (104) must have at least one topic. A topic of the ED (104) may be associated with one or more of the candidate titles and sections.

In one or more embodiments, a portion of the ED (104) is a part (i.e., area) of the ED (104) identified based on differentiating the contents of the ED (104). For example, assume that the ED (104) includes part A with content A and part B with content B. Further assume that content A and content B are different. Part A and part B of the ED (104) would each be identified as a portion of the ED (104). In one or more embodiments, each non-text object in the ED (104) is identified as a portion of the ED (104). Differentiating the contents of the ED (104) may be based on the topics (i.e., different topics are treated as different content). The ED (104) includes at least one portion (i.e., the entirety of the ED (104) is treated as a single portion). A portion may include one or more other portions that are nested or presented in a hierarchical manner within the portion. A portion of the ED (104) may be associated with one or more of the candidate titles and sections (i.e., a portion of the ED (104) may be associated with one or more topics of the ED (104)).

In one or more embodiments, a single visual inferencer may be used to identify the candidate titles and sections in the ED (104). Alternatively, multiple visual inferencers may be used to identify the candidate titles and sections (e.g., one or more visual inferencers for the candidate titles and one or more visual inferencers for the candidate sections). Similarly, a single semantic inferencer may be used to identify the topics and portions in the ED (104). Alternatively, multiple semantic inferencers may be used to identify the topics and portions (e.g., one or more semantic inferencers for the topics and one or more semantic inferencers for the portions).

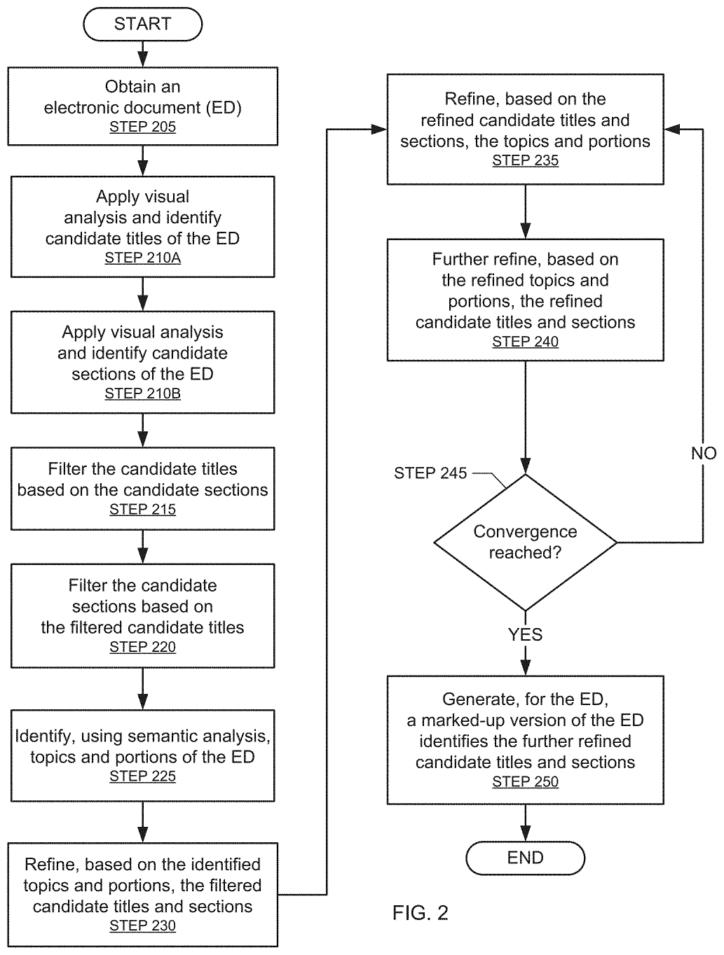

The system (100) includes the convergence engine (108). The convergence engine (108) may be implemented in hardware (i.e., circuitry), software, or any combination thereof. The convergence engine (108) works in tandem with the inference engine (106) to execute an iterative process of one or more embodiments for inferring the titles and sections of the ED (104) by applying the visual and semantic analysis in a predetermined order. The iterative process of one or more embodiments is described in more detail below with reference to the flowchart shown in FIG. 2.

The convergence engine (108) further generates a marked-up version of the ED (104) with the candidate titles and sections identified (i.e., distinguished from the other contents of the ED (104)) for the user using boxes, highlighting, etc.). In one or more embodiments, the results of the identified titles and sections in the marked-up version of the ED (104) may vary based on the type(s) of visual and semantic inferencers applied to the ED (104).

Although the system (100) is shown as having three components (102, 106, 108), in other embodiments of the invention, the system (100) may have more or fewer components. Further, the functionality of each component described above may be split across components. Further still, each component (102, 106, 108) may be utilized multiple times to carry out an iterative operation.

FIG. 2 shows a flowchart in accordance with one or more embodiments of a process for processing an electronic document (ED) to infer titles and sections of the ED. One or more of the steps in FIG. 2 may be performed by the components of the system (100), discussed above in reference to FIG. 1. In one or more embodiments of the invention, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2.

Initially, an ED is obtained (STEP 205). The ED may include a combination of: one or more lines of texts made up of characters, non-text objects, etc.). The ED (104) may be obtained (e.g., downloaded, scanned, etc.) from any source. The ED (104) may be a single-paged document or a multi-paged document. Further, the ED (104) may be of any size and in any format (e.g., PDF, OOXML, ODF, HTML, etc.). The ED includes at least one section, at least one topic, at least one portion, and may not include a title.

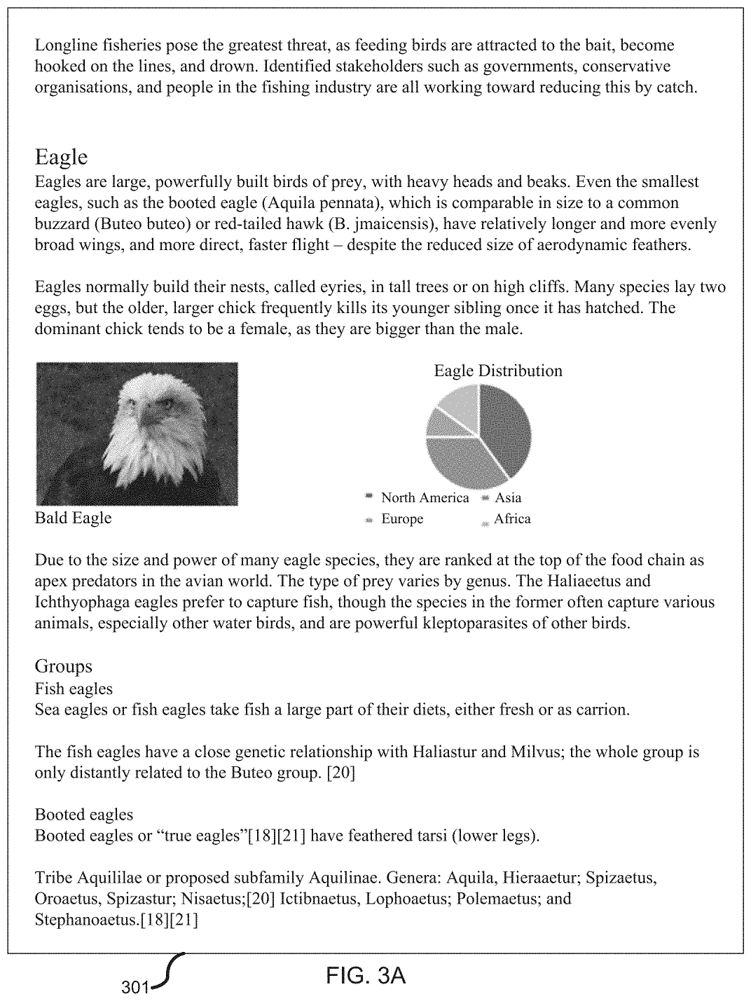

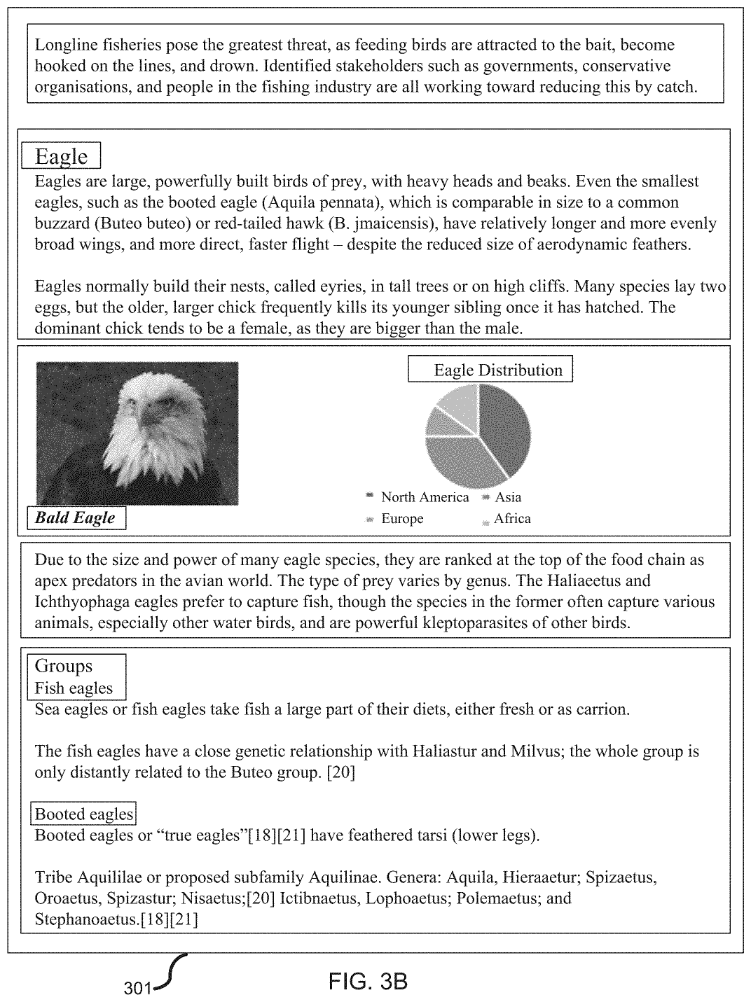

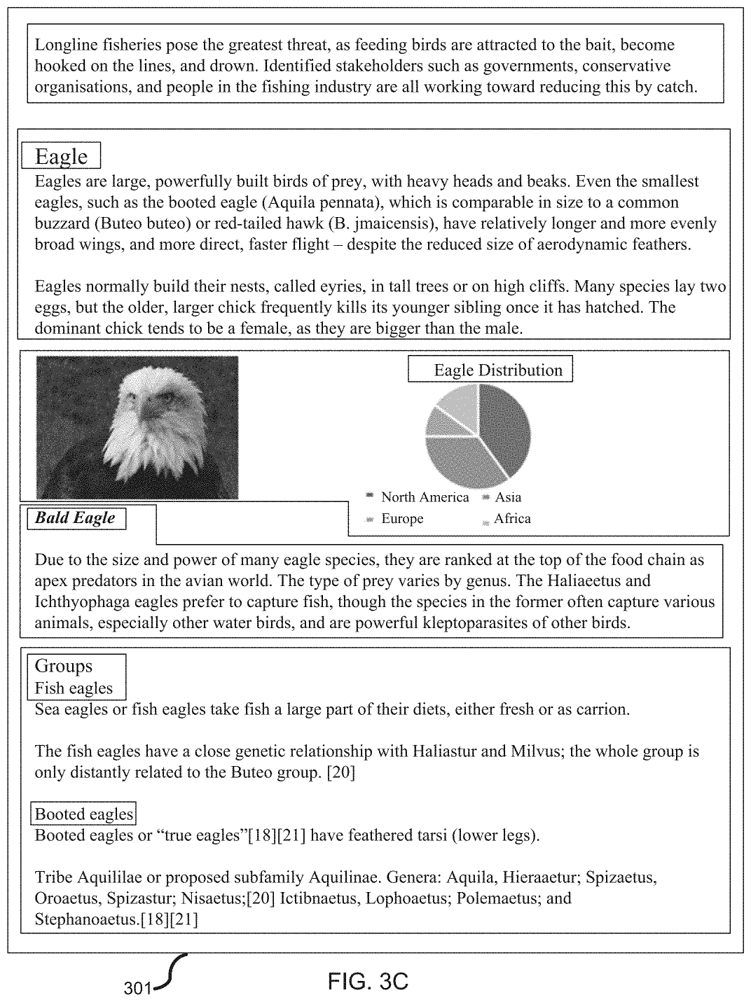

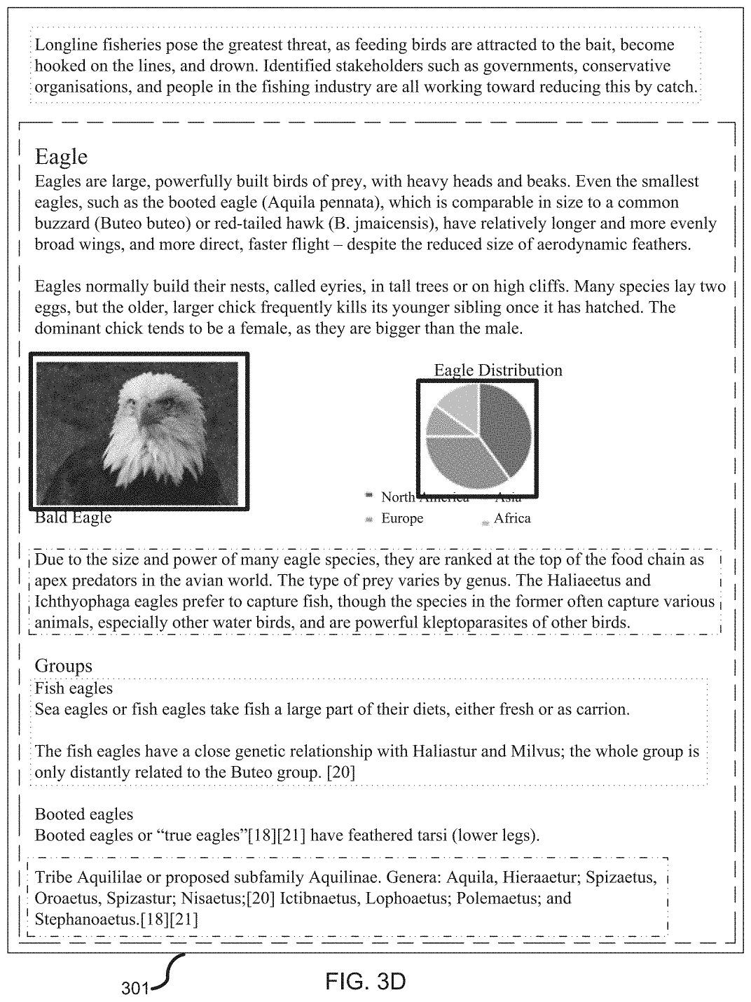

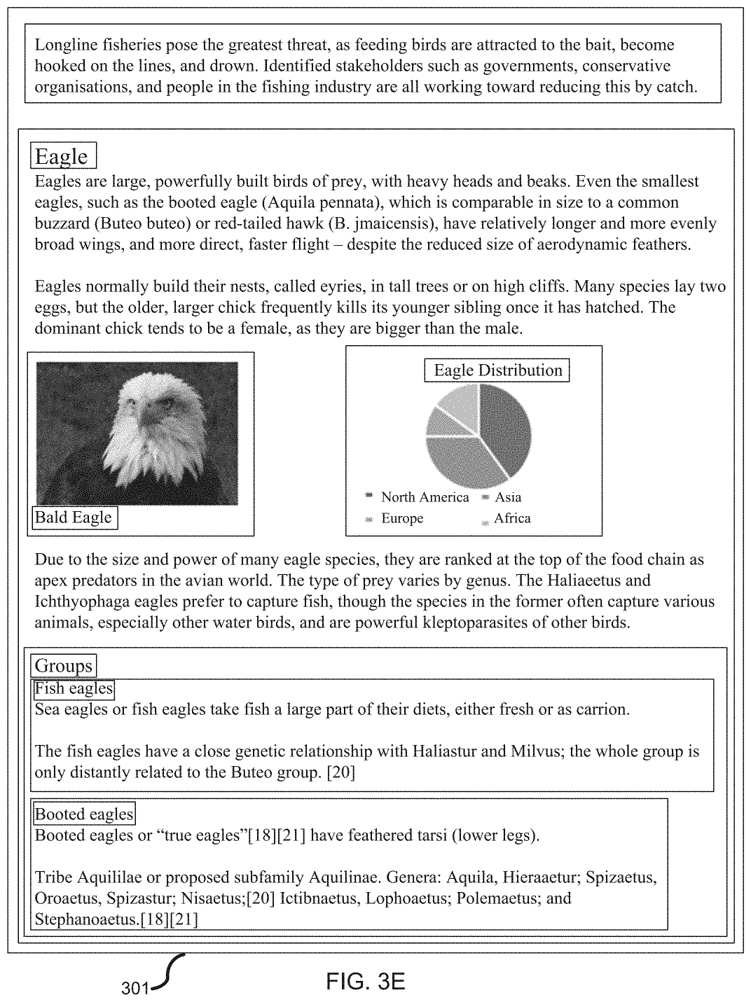

In STEP 210A, using the visual inferencers as discussed above in reference to FIG. 1, visual analysis is applied to the ED to identify candidate titles of the ED. In STEP 210B, using the visual inferencers as discussed above in reference to FIG. 1, visual analysis is applied to the ED to identify candidate sections of the ED. This is exemplified in more detail below in FIG. 3B.

In STEP 215, the visual inferencers are applied to the ED to filter (i.e., refine) the candidate titles identified in STEP 210A while considering (i.e., based on) the candidate sections identified in STEP 210B. In STEP 220, the visual inferencers are applied to the ED to filter the candidate sections identified in STEP 210B while considering the candidate titles filtered in STEP 215 (i.e., the filtered candidate titles).

In one or more embodiments, the degree of change (i.e., the number of new candidate titles and sections identified, the number of identified candidate titles and sections eliminated, the association between the identified candidate titles and sections, etc.) to the identified candidate titles and sections that may occur in STEPs 215 and 220 depends on the specificity of the analysis performed by the visual inferencers (i.e., depends on the capabilities of the visual inferencers). Use of different types of visual inferencers may produce different results in STEPs 215 and 220. This is exemplified in more detail below in FIG. 3C.

In STEP 225, using the semantic inferencers as discussed above in reference to FIG. 1, semantic analysis is applied to the ED to identify topics and portions and associate the identified portions with the identified topics. This is exemplified in more detail below in FIG. 3D.

In STEP 230, the candidate titles and sections filtered in STEPs 215 and 220 (i.e., the filtered candidate titles and sections) are re-evaluated and refined, using a combination of the visual and semantic inferencers, based on the topics and portions identified in STEP 225.

In one or more embodiments, the filtered candidate titles and sections are refined based on the topics and portions by providing the visual inferencers with refined inputs based on only parts of the ED. For example, one refined input to the inferences may be based on one of the portions identified in STEP 230 (e.g., visual analysis by the visual inferencers is performed only on that single portion). Employing these refined inputs narrows the focus of the visual inferencers, which causes certain visual features of the ED (i.e., the style and layout information of the ED or certain bits in the rendered bitmaps) to stand out more compared to applying visual analysis on the entire ED.

The focus of the visual inferencers may be narrowed to focus on parts with potential inconsistencies. For example, a potential inconsistency may be identified, with the help of the information identified by the semantic inferencers, between one or more candidate titles and a certain topic associated with the candidate titles (i.e., a candidate title seems less likely to be an actual title of the ED given the topic associated with the candidate title). The focus of the visual inferencers may then be narrowed to that part (i.e., one or more portions or candidate sections) around the potential inconsistency.

The focus of the visual inferencers may also be narrowed to focus on the non-text objects. For example, a non-text object may be associated with a caption (i.e., a title of a non-text object) that describes the non-text object. The caption may also be within a predetermined area of the non-text object in order for users to easily identify and comprehend the non-text object. The focus of the visual inferencers may then be narrowed to focus on this predetermined area in order to look for previously identified candidate titles that may potentially be the caption of the non-text object.

In one or more embodiments, determining the refined inputs may also be based on masking out parts of the ED before further visual analysis is applied. These masked out parts may include candidate titles and sections that prior visual analysis in STEPs 210A to 220 deemed to be unlikely titles of the ED. Parts of the ED that are not masked out are then submitted as the refined inputs for further analysis.

In STEP 235, the topics and portions identified in STEP 230 are re-evaluated and refined, using a combination of the visual and semantic inferencers, based on the filtered candidate titles and sections that were re-evaluated and refined in STEP 230.

In STEP 240, the refined candidate titles and sections from STEPs 230 are further re-evaluated and refined, using a combination of the visual and semantic inferencers, based on the topics and portions that were re-evaluated and refined in STEP 235.

In one or more embodiments, the degree of change to the filtered candidate titles and sections and to the topics and portions that may occur in STEPs 230 to 240 after the re-evaluation and refinement may depend on the specificity of the analysis performed by the visual and semantic inferencers (i.e., depends on the capabilities of the visual and semantic inferencers). Application of different types of visual and semantic inferencers may produce different results. This is discussed in more detail below in the description of FIG. 3E.

In STEP 245, a determination is made whether a point of convergence has been reached (i.e., a point where further refinement will no longer cause any changes and/or yield any different results). If the determination in STEP 245 is NO, the process returns to STEP 235 where the candidate titles and sections and the topics and portions are further refined based on one another.

If the determination in STEP 245 is YES, a marked-up version of the ED, as discussed above in reference to FIG. 1, is generated identifying all of the remaining candidate titles and sections after all further re-evaluation and refining has been concluded.

FIGS. 3A to 3E show an implementation example according to one or more embodiments. As shown in FIG. 3A, an electronic document (ED) (301) includes one or more lines of texts and non-text objects (e.g., the picture of the eagle and the pie chart). The iterative process of one or more embodiments discussed above in reference to FIGS. 1 and 2 is executed on the ED (301). In one or more embodiments, the results of the iterative process presented in FIGS. 3B to 3E may vary depending on the types of visual and semantic inferencers executed on the ED (301).

FIG. 3B shows the ED (301) after an initial identification of the candidate titles and sections, as discussed above in STEPs 210A and 210B of FIG. 2. As seen in FIG. 3B, the candidate titles and sections are identified by being enclosed in a solid-line box. The visual inferencers have identified certain texts with unique styles and layouts as candidate titles and distinctive parts of the ED (310) as candidate sections.

FIG. 3C shows the ED (301) after the initially-identified candidate titles and candidate sections have be filtered, as discussed above in STEPs 215 and 220 of FIG. 2. As shown in FIG. 3C, there are no changes to the candidate titles (i.e., the degree of change to the candidate titles as a result of STEP 215 is zero). However, the boundaries that delimit two of the boxes of the candidate sections have been changed. Specifically, the candidate section including the two non-text objects no longer includes the candidate title of “Bald Eagle.” The candidate title “Bald Eagle” is now included in the candidate section immediately beneath the candidate section with the two non-text objects.

FIG. 3D shows the ED (301) after the initial identification of the topics and portions, as discussed above in STEPs 225. As seen in FIG. 3D, the identified portions of the ED may overlap. The identified portions are shown as being enclosed by different styled boxes. The style of the boxes is based on the identified topics including: “Birds,” “Eagle,” “Fish,” and “Science.” The overall topic of the ED (301) has been identified as “Birds.” The box with the long-short-short dash lines illustrate a portion of the ED (301) that has been associated with the topic “Eagle.” The boxes with the dotted lines illustrate portions of the ED (301) that have been associated with the topic “Fish.” The boxes with the dash-dot-dot lines illustrate portions of the ED (301) associated with the topic “Science.” The boxes with the thick solid lines are used to illustrate portions of the ED (104) that include non-text objects, which are not associated with any topics.

FIG. 3E shows a marked-up version of the ED (301) after a determination that convergence has been reached, as discussed above in STEPs 230 to 245 of FIG. 2. As seen in FIG. 3E, the scope of the visual and semantic analysis has been narrowed and focused on distinct parts of the ED (301). This is evident where the non-text objects are identified as separate candidate sections each including a candidate title (i.e., each including a caption). Certain candidate sections shown in FIG. 3B have been expanded to cover other candidate sections (i.e., these sections have become major sections that include one or more nested/hierarchical minor sections). Each candidate section, except for the top-most candidate section, is also shown to include at least one candidate title. A direct visual inspection by a user would reveal that all of the titles and sections of the ED (301) have been accurately identified.

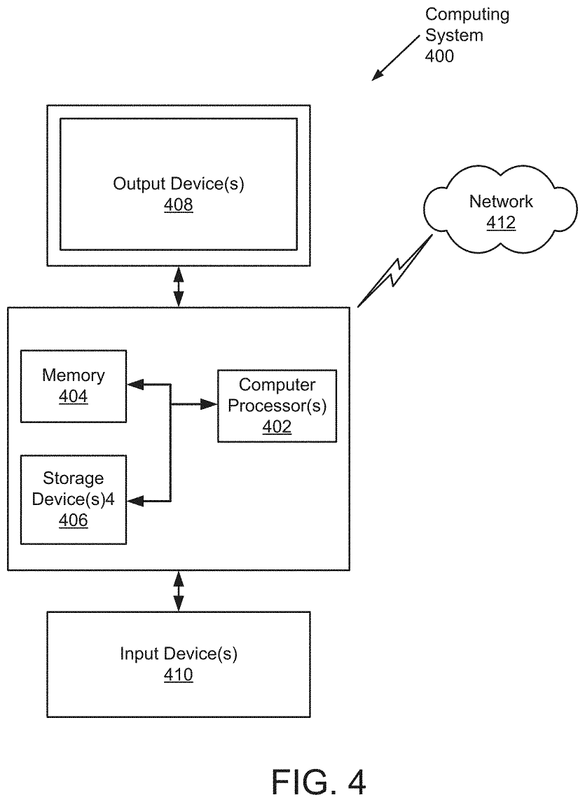

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform embodiments of the invention.

Further, one or more elements of the aforementioned computing system (400) may be located at a remote location and be connected to the other elements over a network (412). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

One or more embodiments of the invention may have one or more of the following advantages: the ability to accurately identify the titles and sections of one more electronic documents that do not include tags; the ability to identify any incorrectly tagged titles and sections of electronic documents; the ability to execute the above identification without intervention by a user; etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for processing an electronic document (ED) to infer titles and sections in the ED, the method comprising:
applying visual analysis to the ED and identifying candidate titles and candidate sections of the ED;
filtering the candidate titles based on the candidate sections;
filtering the candidate sections based on the filtered candidate titles;
applying semantic analysis to the ED and identifying topics and portions of the ED;
refining, based on the identified topics and the portions, the filtered candidate titles and the filtered candidate sections; and
generating a marked-up version of the ED that identifies the refined candidate titles and the refined candidate sections.

2. The method of claim 1, further comprising:
refining, based on the refined candidate titles and the refined candidate sections, the topics and portions;
further refining, based on the refined topics and the refined portions, the refined candidate titles and the refined candidate sections; and
generating a marked-up version of the ED that identifies the further refined candidate titles and the further refined candidate sections.

3. The method of claim 1, wherein the refining of the candidate titles and the candidate sections further comprises:
re-applying the visual analysis to only a first portion among the portions, wherein the first portion is associated with a first topic among the topics;
comparing the filtered candidate titles and the filtered candidate sections identified within the first portion to the first topic, wherein the filtered candidate titles and the filtered candidate sections within the first portion are associated with a second topic among the topics; and
determining, based on the first topic matching the second topic, that the filtered candidate titles and the filtered candidate sections within the first portion are associated with the first portion.

4. The method of claim 3, wherein the method further comprises:
identifying, based on executing the visual analysis and the semantic analysis on an entirety of the ED, a possible inconsistency between the first topic and the second topic; and
selecting the first portion based on the possible inconsistency.

5. The method of claim 1, wherein
each of the candidate sections is associated with at least one of the candidate titles, and
the refining of the filtered candidate titles and the filtered candidate sections further comprises:
identifying a first filtered candidate section among the filtered candidate sections that is not associated with any of the filtered candidate titles;
re-applying the visual analysis to only the first filtered candidate section;
determining that the first filtered candidate section includes a non-text object;
searching, using the visual analysis, for any of the filtered candidate titles within a predetermined area of the non-text object;
determining, based on identifying a first filtered candidate title among the filtered candidate titles within the predetermined area, that the first filtered candidate title is a title of the second filtered candidate section.

6. The method of claim 1, wherein
the ED comprises multiple pages, and
the refining of the filtered candidate titles and the filtered candidate sections further comprises:
dividing, based on the topics or the portions, the ED into a first subset of the pages and a second subset of the pages that do not overlap; and
separately re-applying the visual analysis to the first subset and the second subset to identify any missed candidate titles and sections within the first subset and the second subset.

7. The method of claim 1, wherein the refining of the filtered candidate titles and the filtered candidate sections further comprises:
dividing, based on the topics or the portions, the ED into a first part and a second part that do not overlap, wherein the second part is masked; and
re-applying the visual analysis to only the first part to identify any missed candidate titles and sections within the first area.

8. The method of claim 1, wherein the titles and the sections of the ED do not include tags.

9. The method of claim 1, wherein the visual analysis is applied using a Convolution Neural Network (CNN) in combination with a Recurrent Neural Network (RNN).

10. The method of claim 1, wherein the semantic analysis is applied using Natural Language Processing (NLP).

11. A non-transitory computer readable medium (CRM) storing computer readable program code for processing an electronic document (ED) to infer titles and sections in a parsed version of the ED embodied therein, the computer readable program code causes a computer to:
apply visual analysis to the ED and identify candidate titles and candidate sections of the ED;
filter the candidate titles based on the candidate sections;
filter the candidate sections based on the filtered candidate titles;
apply semantic analysis to the ED and identify topics and portions of the ED;
refine, based on the identified topics and the portions, the filtered candidate titles and the filtered candidate sections; and
generate a marked-up version of the ED that identifies the refined candidate titles and the refined candidate sections.

12. The CRM of claim 11, wherein the computer readable program code further causes a computer to:
refine, based on the refined candidate titles and the refined candidate sections, the topics and portions;
further refine, based on the refined topics and the refined portions, the refined candidate titles and the refined candidate sections; and
generate a marked-up version of the ED that identifies the further refined candidate titles and the further refined candidate sections.

13. The CRM of claim 11, wherein the refining of the candidate titles and the candidate sections further comprises:
re-applying the visual analysis to only a first portion among the portions, wherein the first portion is associated with a first topic among the topics;
comparing the filtered candidate titles and the filtered candidate sections identified within the first portion to the first topic, wherein the filtered candidate titles and the filtered candidate sections within the first portion are associated with a second topic among the topics; and
determining, based on the first topic matching the second topic, that the filtered candidate titles and the filtered candidate sections within the first portion are associated with the first portion.

14. The CRM of claim 13, wherein the computer readable program code further causes a computer to:
identifying, based on executing the visual analysis and the semantic analysis on an entirety of the ED, a possible inconsistency between the first topic and the second topic; and
selecting the first portion based on the possible inconsistency.

15. The CRM of claim 11, wherein
each of the candidate sections is associated with at least one of the candidate titles, and
the refining of the filtered candidate titles and the filtered candidate sections further comprises:
identifying a first filtered candidate section among the filtered candidate sections that is not associated with any of the filtered candidate titles;
re-applying the visual analysis to only the first filtered candidate section;
determining that the first filtered candidate section includes a non-text object;
searching, using the visual analysis, for any of the filtered candidate titles within a predetermined area of the non-text object;
determining, based on identifying a first filtered candidate title among the filtered candidate titles within the predetermined area, that the first filtered candidate title is a title of the second filtered candidate section.

16. A system for processing an electronic document (ED) to infer titles and sections in a parsed version of the ED, the system comprising:
a memory; and
a processor coupled to the memory, wherein the processor:
applies visual analysis to the ED and identifies candidate titles and candidate sections of the ED;
filters the candidate titles based on the candidate sections;
filters the candidate sections based on the filtered candidate titles;
applies semantic analysis to the ED and identifies topics and portions of the ED;
refines, based on the identified topics and the portions, the filtered candidate titles and the filtered candidate sections; and
generates a marked-up version of the ED that identifies the refined candidate titles and the refined candidate sections.

17. The system of claim 16, wherein the processor further:
refines, based on the refined candidate titles and the refined candidate sections, the topics and portions;
further refines, based on the refined topics and the refined portions, the refined candidate titles and the refined candidate sections; and
generates a marked-up version of the ED that identifies the further refined candidate titles and the further refined candidate sections.

18. The system of claim 16, wherein the refining of the candidate titles and the candidate sections further comprises:
re-applying the visual analysis to only a first portion among the portions, wherein the first portion is associated with a first topic among the topics;
comparing the filtered candidate titles and the filtered candidate sections identified within the first portion to the first topic, wherein the filtered candidate titles and the filtered candidate sections within the first portion are associated with a second topic among the topics; and
determining, based on the first topic matching the second topic, that the filtered candidate titles and the filtered candidate sections within the first portion are associated with the first portion.

19. The system of claim 18, wherein the processor further:
identifies, based on executing the visual analysis and the semantic analysis on an entirety of the ED, a possible inconsistency between the first topic and the second topic; and
selects the first portion based on the possible inconsistency.

20. The system of claim 16, wherein
each of the candidate sections is associated with at least one of the candidate titles, and
the refining of the filtered candidate titles and the filtered candidate sections further comprises:
identifying a first filtered candidate section among the filtered candidate sections that is not associated with any of the filtered candidate titles;
re-applying the visual analysis to only the first filtered candidate section;
determining that the first filtered candidate section includes a non-text object;
searching, using the visual analysis, for any of the filtered candidate titles within a predetermined area of the non-text object;
determining, based on identifying a first filtered candidate title among the filtered candidate titles within the predetermined area, that the first filtered candidate title is a title of the second filtered candidate section.
